(19) United States
(12) Patent Application Publication
(10) Pub. No.: US 2008/0007109 A1
(43) Pub. Date: Jan. 10, 2008

(54) Tire rim locking device

(76) Inventors: Jonathan J. Lawson, Lithonia, GA (US); Ursula King, Tifton, GA (US)

Correspondence Address: SUNG I. OH, PROFESSIONAL LAW CORPORATION, 710 QUAIL VALLEY LANE, WEST COVINA, CA, 91791, US

(21) Appl. No.: 11/481,987

(22) Filed: Jul. 6, 2006

(51) Int. Cl. B60B 7/16

(52) U.S. Cl. 301/37.21

(57) ABSTRACT

A tire locking system includes body that fits over lug nuts associated with a vehicle wheel when the body is in place on the wheel. The system further includes locking elements in the body that move under the influence of a locking mechanism, such as a key lock, between a stored position and a deployed position in which the body is locked to a rim of the vehicle wheel with the body covering the lug nuts.

### TECHNICAL FIELD OF THE INVENTION

This invention relates in general to vehicle wheel accessories, and more particularly to a vehicle wheel locking system.

### BACKGROUND OF THE INVENTION

As is well known in the art, automotive vehicle wheel covers are conventionally supplied on automobiles and other automotive vehicles by the manufacturers thereof for decorative purposes as well as to cover and provide protection for the hub, the lug studs, the lug nuts and the center member of the wheel, also commonly known as the disc or spider of the wheel. The wheel covers supplied by the manufacturers of the vehicles usually fit resiliently against the wheel rim and are intended to be easily removable, as for tire changing purposes, by a screw driver blade, a tire iron or other suitable tool.

The vehicle or automobile wheel has over the years become part of the styling of the automobile and not just a member to hold on a tire. Therefore, many automobile owners order, as an accessory item either from the automobile manufacture or from a local automobile supply house, expensive custom-made or sports-car type hub caps or rims to improve the appearance of their automobile. Many foreign and domestic spots car manufacturers equip their automobiles with attractive, but very expensive, hub caps or rims as a standard item with each automobile. These type of fancy wheels were in the beginning known as “mag” wheels which is an abbreviation for “magnesium” wheels. These “mag” wheels were used on some race cars. However, since a wheel manufactured from magnesium is costly and not practical for the average consumer, the fancy wheels for general use are actually made from aluminum or chrome plated steel. The cast aluminum and chrome plated steel fancy wheels are sold at tire and wheel shops all over the world and since the wheels are a luxury item, they are a prime candidate for thefts.

Since the wheel covers conventionally supplied on modern day vehicles are relatively expensive, and because these hub caps and rims are simple to remove, such wheel covers and rims have become the object of widespread theft in that all four wheel covers on an automobile, for example, can be stolen by a thief in a matter of seconds. The theft of wheels and tires has also become widespread since removal of the wheel covers provides ready access to the wheel stud nuts. It is also well known in the art that chuck holes, rocks and other road hazards can effect sufficient deflection of a wheel rim on a moving vehicle to cause a wheel cover to pop off the wheel, often without the knowledge of the vehicle driver, or under heavy traffic conditions, such as on a freeway, which prevents a driver from retrieving the wheel cover even if the driver is aware of the fact that the wheel cover has separated from the wheel.

Many prior art devices have unsuccessfully attempted to solve this problem. The reasons for their failure vary. Some of the prior art devices are so complex and their parts so intricate that the costs of manufacturing these devices are prohibitive in today's market. Other prior art devices use a variety of parts, that for one reason or another in today's shortages of materials, are either unavailable or scarce. Still other prior art devices have a configuration or shape that may be difficult and expensive to manufacture from an engineering standpoint, and therefore may be too expensive for the average automobile owner. Accordingly, the various devices known to the inventor have been subject to various deficiencies in that they are often relatively expensive, often ineffective, burdensome to install and remove, bulky, or otherwise unattractive. Additionally, such prior devices have often been easily circumvented by thieves.

### SUMMARY OF THE INVENTION

The above-discussed disadvantages of the prior art are overcome by a tire locking system which includes a body having plurality of locking elements thereon that move under the influence of a key mechanism between a stored position and a deployed position in which the locking elements are locked to the rim of the tire with the body covering the lug nuts used to attach the wheel associated with the rim to the rim and locks the body to the rim to prevent access to those lug nuts and to prevent removal of the rim.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a plan view of a body of the tire locking system embodying the present invention.

FIG. 2 is an elevational view of the body shown in FIG. 1.

FIG. 3 is a view showing the body locked in place on the rim of a tire in position covering lug nuts associated with the rim.

FIG. 4A shows a tire without the hub cap lock in place.

FIG. 4B shows a tire with the hub cap lock in place.

### DETAILED DESCRIPTION OF THE INVENTION

Referring to the figures, it can be understood that the present invention is embodied in a tire lock system 10 embodying the present invention. System 10 comprises a tire rim 12 on which a tire T is mounted. Tire rim 12 has a central portion 14 which accommodates lug nuts 16 used to attach the tire rim to a motor vehicle. Central portion 14 has a surface 20 thereon.

A cylindrical bore 22 is defined in the central portion and an inner surface 24 is defined on the central portion adjacent to the cylindrical bore. Cylindrical bore 22 has an inner dimension 26 defined by the inner surface. A groove 30 is defined in the inner surface of the tire rim adjacent to the cylindrical bore. Groove 30 extends radially from the cylindrical bore. A body 40 includes a dome shaped portion 42 which has an outer perimeter 44. Outer perimeter 44 of the dome shaped portion having an outer dimension 46 that is greater than inner dimension 26 of the cylindrical bore of the tire rim.

Body 40 further includes a cylindrical base portion 50 having one end 52 connected to the dome shaped portion and a second end 54 spaced apart from the dome shaped portion. An interior volume 60 is defined in the cylindrical base portion. Base portion 50 further includes a perimeter 64 that has an outer dimension 66 is essentially equal to inner dimension 26 of the cylindrical bore of the tire rim and smaller than the dimension of perimeter 46 of the dome shaped portion.

An annular section 70 is defined on the dome shaped portion by the dome shaped portion circumjacent to the cylindrical base portion. Annular section 70 is adapted to engage surface 20 of the central portion of the tire rim when the body is in place on an tire rim. Body 40 is shaped and sized so that lug nuts 16 associated with the tire associated with the tire rim are accommodated in interior volume 60 when the body is in place on the tire rim.

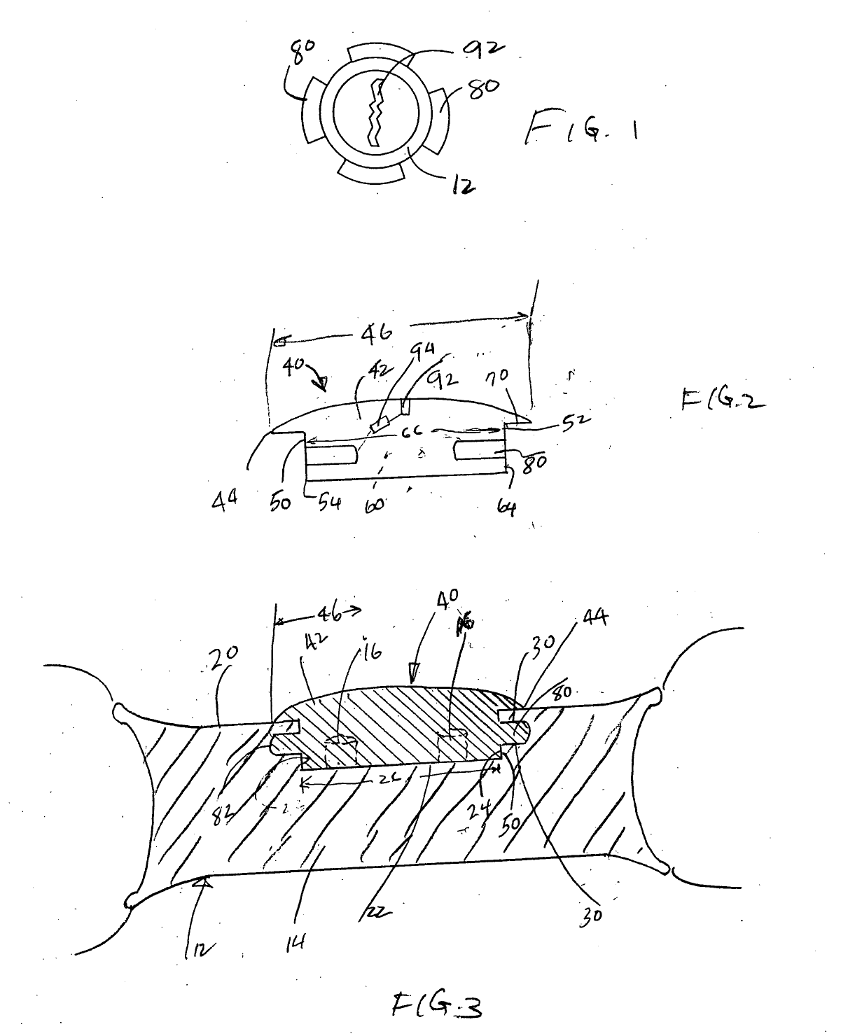

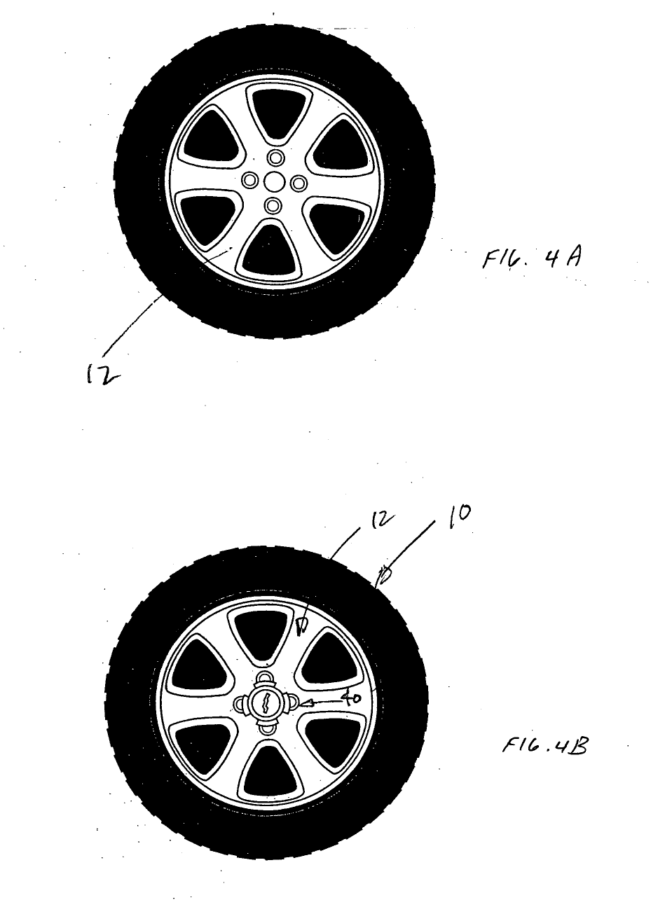

A plurality of locking elements 80 are movably mounted on cylindrical base portion 50. The locking elements are movable between a stored position inside the cylindrical base portion shown in FIG. 2 and a deployed position shown in FIGS. 1 and 3 extending out of the cylindrical base portion to have a portion 82 of each of the locking elements extending beyond perimeter 64 of the cylindrical base portion and into groove 30 defined in the inner surface of the tire rim. Each of the locking elements is adapted to engage the tire rim adjacent to the groove to lock the body to the tire rim in position to cover the lug nuts accommodated in the interior volume in the dome shaped portion and in the cylindrical base portion.

A locking mechanism 90 is located in the dome shaped portion. The locking mechanism includes a key lock portion 92 in the dome shaped portion and a moving mechanism 94 operatively connecting the key lock portion to the locking elements to move the locking elements between the stored position and the deployed position in response to movement of the key lock portion. The key lock portion and the moving mechanism can be any type of elements and systems common to key locks to move tumblers and the like as will be understood by those skilled in the lock art. The exact mechanisms and elements are not important to this invention and will not be claimed. As such, these elements will not be discussed.

Use of the system can be understood from the teaching of this disclosure and thus will only be briefly discussed. As shown in FIG. 4A, the basic rim supports a tire. To protect the rim from unauthorized removal, the locking system of the present invention is placed onto the rim as indicated in FIG. 3, a key inserted into the body and turned to extend the locking elements into the groove on the rim. The body covers the lug nuts and is locked onto the rim as indicated in FIG. 3.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A tire locking system comprising:
A) a tire rim which has
(1) a central portion which accommodates lug nuts used to attach the tire rim to a motor vehicle, the central portion having a surface thereon,
(2) a cylindrical bore defined in the central portion,
(3) an inner surface defined on the central portion adjacent to the cylindrical bore, the cylindrical bore having an inner dimension defined by the inner surface, and
(4) a groove defined in the inner surface of the tire rim adjacent to the cylindrical bore, the groove extending radially from the cylindrical bore,
B) a body which has
(1) a dome shaped portion which includes
(a) an outer perimeter, the outer perimeter of the dome shaped portion having an outer dimension that is greater than the inner dimension of the cylindrical bore of the tire rim,
(b) a cylindrical base portion having one end connected to the dome shaped portion and a second end spaced apart from the dome shaped portion,
(c) an interior volume in the cylindrical base portion, and
(2) a perimeter on the cylindrical base portion, the perimeter of the cylindrical base portion having an outer dimension that is essentially equal to the inner dimension of the cylindrical bore of the tire rim and smaller than the perimeter of the dome shaped portion,
(3) an annular section defined on the dome shaped portion by the dome shaped portion circumjacent to the cylindrical base portion, the annular section being adapted to engage the surface of the central portion of the tire rim when the body is in place on an tire rim, and
(4) the body being shaped and sized so that lug nuts associated with the tire associated with the tire rim are accommodated in the interior volume when the body is in place on the tire rim;
C) a plurality of locking elements movably mounted on the cylindrical base portion, the locking elements being movable between a stored position inside the cylindrical base portion and a deployed position extending out of the cylindrical base portion to have a portion of each of the locking elements extending beyond the perimeter of the cylindrical base portion and into the groove defined in the inner surface of the tire rim, each of the locking elements being adapted to engage the tire rim adjacent to the groove to lock the body to the tire rim in position to cover the lug nuts accommodated in the interior volume in the dome shaped portion and in the cylindrical base portion; and
C) a locking mechanism in the dome shaped portion, the locking mechanism including
(1) a key lock portion in the dome shaped portion, and
(2) a moving mechanism operatively connecting the key lock portion to the locking elements to move the locking elements between the stored position and the deployed position in response to movement of the key lock portion.

2. A tire locking system comprising:
A) a tire rim having an inner surface, the inner surface having a groove, the tire rim adapted to receive lug nuts;
B) a body having a dome shape portion, the dome shape portion including a cylindrical base portion; and
C) a plurality of locking elements movably mounted on the cylindrical base portion, the locking elements being movable between a stored position inside the cylindrical base portion and a deployed position extending out of the cylindrical base portion to have a portion of each of the locking elements extending beyond the perimeter of the cylindrical base portion and into the groove defined in the inner surface of the tire rim, each of the locking elements being adapted to engage the tire rim adjacent to the groove to lock the body to the tire rim in position to cover the lug nuts accommodated in the interior volume in the dome shaped portion and in the cylindrical base portion.

3. The tire locking system according to claim 2, including:
D) a locking mechanism in the dome shaped portion, the locking mechanism including
(1) a key lock portion in the dome shaped portion, and
(2) a moving mechanism operatively connecting the key lock portion to the locking elements to move the locking elements between the stored position and the deployed position in response to movement of the key lock portion.
